(19) United States
(12) Patent Application Publication
(10) Pub. No.: US 2026/0097450 A1
(43) Pub. Date: Apr. 9, 2026

(54) METHOD AND APPARATUS FOR LASER-MARKING OBJECTS WITH A CURVED FACE

(71) Applicant: KRONES AG, Neutraubling (DE)

(72) Inventor: Andreas KRAUS, Lappersdorf (DE)

(21) Appl. No.: 19/352,003

(22) Filed: Oct. 7, 2025

(30) Foreign Application Priority Data
Oct. 7, 2024 (DE) 10 2024 128 858.2

(51) Int. Cl. B23K 26/352; B23K 26/042; B23K 26/08; B23K 26/082; B41J 2/44

(52) U.S. Cl. CPC B23K 26/355; B23K 26/042; B23K 26/082; B23K 26/083; B41J 2/442

(57) ABSTRACT

The invention relates, inter alia, to a method for laser-marking objects with a curved face. A two-dimensional representation of a desired laser mark is provided. The provided two-dimensional representation is adjusted depending upon the curvature of the curved face. A laser mark is laser-marked on the curved face of an object by means of a laser-marking system depending upon the adjusted two-dimensional representation.

### CROSS REFERENCE TO RELATED APPLICATIONS

This application claims the benefit under 35 U.S.C. § 119(a) of German Patent Application No. DE 10 2024 128 858.2, filed Oct. 7, 2024, METHOD AND APPARATUS FOR LASER-MARKING OBJECTS WITH A CURVED FACE, and whose entire disclosure is incorporated by reference herein.

### TECHNICAL FIELD

The invention relates to a method and an apparatus for laser-marking objects, preferably containers, with a curved face.

### TECHNICAL BACKGROUND

Standardly, the majority of containers are fitted with labels. Typical variants are paper or plastic labels, which are processed with hot or cold glue or are self-adhesive and applied to the containers.

Labels can be problematic in the recycling process, e.g., due to the printing ink used, waterproof paper, glue, etc. In the context of the increasing global sustainability discussions, various technology-inherent features can be considered disadvantageous. These include, in particular, the use of plastics for container decoration, a poor CO₂ footprint in label production (especially plastics), logistics, and application (especially shrink sleeves), as well as limited recyclability in the usual waste streams. Analogous points can also be mentioned for the direct printing processes.

In principle, it is therefore desirable to dispense with labels completely. Required information could, for example, be marked or written directly on the containers using a laser-marking system. This technology is already used, for example, to laser-mark a production number or a “best used before” date. During laser-marking, the laser beam and the heat it generates on the surface of the container can cause a physical change to the surface of the container (e.g., whitening of PET containers) so that the desired marks can be laser-marked on the surface.

For example, GB 2576220 A discloses a laser-marking apparatus for marking containers.

Typical laser-marking systems use optics, which provide a planar focal plane. The laser-marking system is therefore optimized for laser-marking on a two-dimensional face in the planar focal plane.

If curved three-dimensional faces are to be laser-marked, this may still be possible with sufficient sharpness, depending upon the depth of field (DOF). However, depending upon the curvature and the associated variable distance from the planar focal plane, a deviation between the actual and target position of the incident laser beam may occur. This deviation can cause distortions in the graphics or text which are visually conspicuous and unattractive, resulting in a diminished impression of quality.

The invention is based upon the object of providing an improved technique for laser-marking containers, with which the quality of a laser-mark on a curved face of an object can preferably be improved, preferably without performance restrictions.

### SUMMARY OF THE INVENTION

The object is achieved by the features of the independent claims. Advantageous developments are specified in the dependent claims and the description.

One aspect relates to an (e.g., computer-aided) method for laser-marking objects, preferably containers, with an (e.g., circular-cylindrical) curved (e.g., lateral) face. The method comprises the following:
providing a two-dimensional representation (image) of a desired laser mark (e.g., by means of a processing device);
(e.g., semi-automatically or fully automatically) adjusting the provided two-dimensional representation depending upon a curvature (curvature information, e.g., radius of curvature or other curvature parameter or size derived therefrom) of the curved face (e.g., by means of a processing device);
laser-marking a laser mark on the curved face of (at least) one object using a laser-marking system depending upon the adjusted two-dimensional representation (image).

The method advantageously allows a distortion-free laser mark to be generated on any curved face. This advantageously means that no complex adjustment is necessary when creating movement commands for mirror drives of the laser-marking system. Instead, a distorted two-dimensional representation of the desired laser mark can simply be created and laser-marked by the laser-marking system. The distortion is advantageous such that any distortion resulting from laser-marking on the curved face of the object is reduced or compensated for. Advantageously, this also allows for laser-marking a plurality of objects on an industrial scale without any performance or quality restrictions.

It is possible for the object to have a plurality of curved faces, each of which needs to be provided with its own laser mark. It is understood that the method disclosed herein can be applied accordingly for each of the curved faces or for each desired laser mark.

Preferably, the object(s) can be transported along the laser-marking system by an object conveyor, preferably a container conveyor, during laser-marking.

Preferably, the laser mark can have text, characters, and/or graphic design elements (e.g., lines, circles, and/or shapes having any contour).

In one exemplary embodiment, the method further comprises transmitting the adjusted two-dimensional representation to a control device of the laser-marking system, wherein, for example, the laser-marking system, preferably a marking head of the laser-marking system, is operated by the control device during laser-marking, depending upon the transmitted, adjusted, two-dimensional representation. Advantageously, the method can also be used with a conventional laser-marking system, to which the previously adjusted two-dimensional representation is simply transmitted for laser-marking.

In a further exemplary embodiment, the laser-marking comprises the following:
generating movement commands for a marking head, preferably drive signals for drives of mirrors of the marking head, of the laser-marking system (e.g., by means of the control device), depending upon the adjusted two-dimensional representation; and
transmitting the generated movement commands, preferably the drive signals, to the marking head (e.g., by means of the control device).

Advantageously, the movement commands for the marking head can thus be derived directly from the adjusted two-dimensional representation in order to reduce or compensate for the distortion caused by the laser-marking on the curved face.

In one embodiment, the two-dimensional representation is provided, adapted, and/or transmitted as an image file (graphics file). Alternatively or additionally, the two-dimensional representation can, for example, be a raster graphic or a vector graphic.

In a further embodiment, the adjustment of the provided two-dimensional representation comprises distortion of the provided two-dimensional representation, preferably in edge regions of the provided two-dimensional representation, particularly preferably with increasing intensity of the distortion toward the edge regions. Advantageously, the distortion caused by laser-marking on the curved face can be reduced or compensated for particularly well.

In one embodiment variant, the provided two-dimensional representation is distorted such that at least one of the following conditions is met:
any distortion caused by the curvature of the curved face during laser-marking is reduced or substantially compensated for;
any distortion caused by the curvature of the curved face during laser-marking is inverted; and
the distortion of the provided two-dimensional representation is opposite to a distortion caused by the curvature of the curved face during laser-marking.

In a further embodiment, the method further comprises:
detecting the curvature by means of a preferably optical and/or camera-supported and/or laser-supported detection device, preferably once for a plurality of objects or individually for each object; or
specifying the curvature by means of a user interface, preferably once for a plurality of objects or individually for each object; or
receiving the curvature by means of a communications interface, preferably once for a plurality of objects or individually for each object.

Depending upon the application, more or less complex detection, specification, etc., of the curvature can, advantageously, be implemented.

In one exemplary embodiment, the curved face is a face segment of the lateral face of a circular cylinder, such as in a container.

In a further exemplary embodiment, the adjustment of the provided two-dimensional representation is carried out by means of correction factors which are specified depending upon the curvature and are applied to the provided two-dimensional representation. This advantageously allows for a relatively simple method which can be flexibly adapted for various laser marks.

In a further exemplary embodiment, the adaptation takes into account (e.g., estimated, simulated, or measured) laser beam angles at which a laser beam emitted by the laser-marking system strikes different points on the curved face. This advantageously enables very precise and high-quality laser-marking on the curved face.

In one embodiment, the laser-marking system has planar field focusing optics, preferably having an F-theta lens, which define an (e.g., single) planar (two-dimensional) focal plane. The method disclosed herein can be used particularly advantageously with the planar field focusing optics.

Preferably, a two-dimensional lens field of the planar field optics of the laser-marking system can lie in the planar focal plane.

Preferably, a two-dimensional marking field of the laser-marking system, within which an area can be laser-marked by the laser-marking system, can lie in the planar focal plane.

In a further embodiment, the provided two-dimensional representation is adjusted taking into account geometric deviations determined (e.g., by means of a processing device) between the curved face and the planar focal plane. This also advantageously enables very precise and high-quality laser-marking on the curved face.

In one embodiment variant, laser-marking is carried out in column-segment fashion. This advantageously allows a high marking speed to be achieved on the curved face.

In a further embodiment variant, the method further comprises:
detecting the laser mark on the curved face by means of an (e.g., further) detection device; and
determining a deviation between the detected laser mark and the desired laser mark (e.g., by means of the processing device); and, optionally,
further (e.g., semi-automatically or fully automatically) adjusting the adjusted two-dimensional representation depending upon the determined deviation (e.g., by means of the processing device), preferably to reduce or compensate for the deviation; and
laser-marking a laser mark on the curved face of at least one further object by means of the laser-marking system depending upon the further adjusted two-dimensional representation.

This can advantageously allow for further correction or iterative adjustment to gradually achieve the desired laser-mark.

A further aspect relates to an apparatus for laser-marking objects, preferably containers, with an (e.g., circular-cylindrical) curved (e.g., lateral) face, wherein the apparatus has a laser-marking system and is configured to carry out a method as disclosed herein.

Advantageously, the apparatus can be used to secure the same advantages already described with reference to the method.

It is understood that all features disclosed herein with reference to the method are also disclosed and claimable in combination with the apparatus, individually and in any combination. Likewise, all features disclosed herein with reference to the apparatus are also disclosed and claimable in combination with the method, individually and in any combination.

For example, the apparatus can have a processing device that is configured to:
adjust a provided two-dimensional representation of a desired laser mark depending upon a curvature of the curved face; and
send the adjusted two-dimensional representation to a control device of a laser-marking system.

For example, the laser-marking system can have a control device that is configured to:
receive the adjusted two-dimensional representation; and
operate the laser-marking system, e.g., its marking head, depending upon the received, adjusted two-dimensional representation for laser-marking a laser mark on the curved face.

In a further exemplary embodiment, the apparatus further has an object conveyor, preferably a container conveyor, for conveying the objects along the laser-marking system, preferably during laser-marking by means of the laser-marking system. This can advantageously allow for continuous operation on an industrial scale and integration into a container processing plant.

A further aspect relates to a container processing plant that is configured to carry out a method as disclosed herein and/or that has an apparatus as disclosed herein. Advantageously, the container processing plant can be used to secure the same advantages already described with reference to the method.

Preferably, the container processing plant can be configured for controlling the temperature of, producing, cleaning, coating, testing, filling, closing, pasteurizing, labeling, printing, marking, laser-marking, and/or packaging containers for liquid or pasty media, preferably beverages, liquid foodstuffs, or products from the pharmaceutical or healthcare industry.

For example, the container processing plant can be a beverage filling plant.

For example, the containers can be realized as bottles, cans, canisters, cartons, vials, tubes, etc.

Preferably, the term “control device” and/or “processing device” can refer to an electronic system (for example, embodied as a driver circuit or with microprocessor(s) and data memory) which, depending upon the configuration, can perform control tasks and/or regulation tasks and/or processing tasks. Although the term “control” is used herein, this can also comprise or be understood as “closed-loop control” or “control with feedback” and/or “processing” as appropriate.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 shows a schematic representation of an exemplary laser-marking system;

FIG. 2 shows a perspectival view of an exemplary apparatus for laser-marking an object;

FIG. 3 shows a schematic representation of a laser-marking process;

FIG. 4 shows a schematic representation to illustrate the occurrence of potential deviations between a desired laser mark and an actual laser mark according to a laser-marking method not according to the invention; and

FIGS. 5 and 6 show schematic representations of a method for laser-marking according to an exemplary embodiment.

The embodiments shown in the drawings correspond at least in part, so that similar or identical parts are provided with the same reference signs, and reference is also made to the description of other embodiments or figures for the explanation thereof to avoid repetition.

### DETAILED DESCRIPTION OF EXEMPLARY EMBODIMENTS

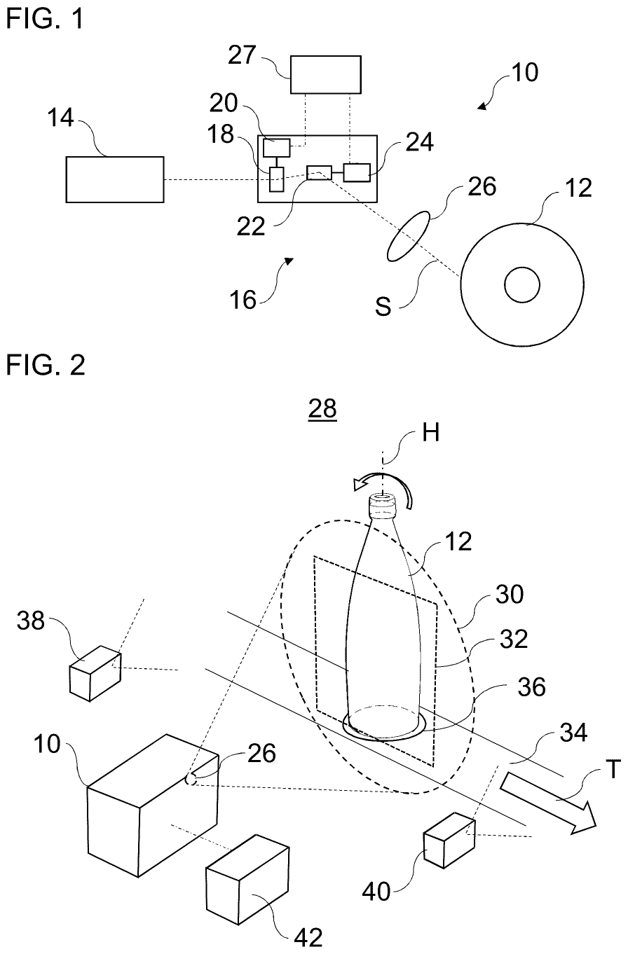

FIG. 1 shows a laser-marking system 10 for laser-marking objects 12. The objects 12 are preferably embodied as containers.

The laser-marking system 10 can also be referred to as a laser identification system, laser-coding system, or laser-inscription system. Preferably, the laser-marking system 10 can be a CO₂ laser-marking system, a fiber laser-marking system, or a UV laser-marking system.

Preferably, the laser-marking system 10 can have a laser source 14, a marking head 16, focusing optics 26, and/or a control device 27. The focusing optics 26 can, for example, be integrated with the marking head 16 or arranged separately from the marking head 16.

The laser source 14 can be embodied as a laser tube, for example. The laser tube may be sealed. The laser tube can be filled with a gas, e.g., containing CO₂, or a gas mixture, e.g., a CO₂—N₂—He gas mixture. Electrodes can also be arranged in the laser tube. A supply unit can be connected to the electrodes (not shown in FIG. 1). The supply unit can supply the laser source 14 with electrical energy. By means of a, for example, high-frequency voltage, molecules, e.g., CO₂ molecules, can be excited to oscillate in the laser tube and thus to emit a laser beam S. The laser source 14 can also be referred to as an oscillator.

The laser beam S generated by the laser source 14 can be guided or directed to the marking head 16 directly or via mirrors. It is possible for a so-called telescope for expanding the laser beam S to be arranged between the laser source 14 and the marking head 16, for example.

The marking head 16 can preferably have two movable mirrors 18 and 22 and two drives 20 and 24. The marking head 16 can also be referred to as a coding head or writing head.

The first drive 20 can rotate the first mirror 18 about a first axis (e.g., x-axis). The first mirror 18 can, for example, also be referred to as a movable scanner mirror, e.g., an X-scanner mirror. The second drive 24 can rotate the second mirror 22 about a second axis (e.g., y-axis). The second mirror 22 can, for example, also be referred to as a movable scanner mirror, e.g., a Y-scanner mirror. The first axis and the second axis can preferably run perpendicular to each other.

The mirrors 18, 22 moved by the drives 20, 24 can direct the laser beam according to the laser mark to be applied. This allows the laser beam S to move across the surface of the object 12 while writing, for example. Preferably, the laser beam S can move across the surface of the object 12 within the marking field 32 (see FIG. 2) which is assigned to the particular marking head 16.

It is possible for the laser-marking system 10 to have a plurality of marking heads 16. The plurality of marking heads 16 can, for example, be arranged laterally side-by-side and/or one above the other. For example, two, three, or more marking heads 16 can be included.

The focusing optics 26 can also be referred to as a condenser or condenser optics. The focusing optics 26 are preferably planar field focusing optics. The planar field focusing optics can specify a planar focal plane. The planar field focusing optics can, for example, be or have an F-theta lens. Before the laser beam S impinges on the curved face of the object 12, it can be focused by means of the focusing optics 26.

Preferably, the planar focal plane can be oriented vertically. Preferably, the planar focal plane is plane-parallel to a laser output side of the focusing optics 26 or the laser-marking system 10.

As already mentioned, the focusing optics 26 can be arranged inside or outside the marking head 16.

The control device 27 can operate the marking head 16 of the laser-marking system 10 to produce a laser mark on a face of the object 12.

For example, the control device 27 can receive a two-dimensional representation (2-D representation). The two-dimensional representation can preferably be received in the form of an image file. The two-dimensional representation can, for example, be a vector graphic or a raster graphic.

Preferably, the control device 27 can operate the drives 20, 24 depending upon the two-dimensional representation. For example, the control device 27 can generate movement commands, such as drive signals, for the drives 20, 24 depending upon the two-dimensional representation, in order to produce the laser mark.

FIG. 2 shows, purely schematically and as an example, an apparatus 28 for laser-marking. The illustrated part of the apparatus 28 has a marking head 16. As already mentioned, the laser-marking system 10 can also have a plurality of marking heads 16, etc. The illustrated part of the apparatus 28 further has an object conveyor 34.

Preferably, the apparatus 28 can be arranged in a container processing plant, e.g., a beverage filling plant, for laser-marking laser marks on curved faces of objects 12 embodied as containers, e.g., bottles or cans.

The arrangement and configuration of the focusing optics 26 can define a so-called focusing field or lens field 30 in the planar focusing plane. The lens field 30 can be two-dimensional. For example, the lens field 30 may have a circular shape. Preferably, the lens field 30 can lie in a vertical plane.

The laser-marking system 10 can be configured for laser-marking within at least one so-called marking field 32.

The marking field 32 may be a portion of the lens field 30. The portion or marking field 32 can comprise all positions which the laser beam S can reach through the movable mirror(s) of the marking head 16. When a region of the object 12 enters the marking field 32, the laser-marking system 10 can laser-mark the region. When the region of the object 12 exits the marking field 32, the laser-marking system 10 can no longer laser-mark the region.

A shape and a dimension of the marking field 32 can be dependent upon the mirrors 18, 22 and the movability thereof as effected by the drives 20, 24 (see FIG. 1). The marking field 32 can be two-dimensional. For example, the marking field 32 may have a rectangular shape, preferably a square shape. Preferably, the marking field 32 can lie in a vertical plane.

Each marking head 16 can form or define its own marking field 32 within the respective lens field 30. A plurality of marking fields 32 can be at least partially spaced apart from one another and/or at least partially adjacent to one another or overlap one another.

The object conveyor 34 can transport the objects 12 in a transport direction T. Depending upon the configuration of the object conveyor 34, it can transport the objects 12 on a desired transport path. The transport path can, for example, be a linear transport path or a curved or arched transport path.

For example, the object conveyor 34 may be a rotary object conveyor (object conveyor carousel). The laser-marking system 10 can, for example, be arranged inside or outside of the rotary object conveyor. It is also possible for the laser-marking system 10 to be arranged partially inside and partially outside the rotary object conveyor. For example, the at least one laser source 14 can be arranged inside the rotary object conveyor, and the at least one marking head 16 can be arranged outside the rotary object conveyor.

Alternatively, the object conveyor 34 can, for example, be a linear object conveyor. The laser-marking system 10 can, for example, be arranged laterally next to the linear object conveyor. The linear object conveyor can, for example, have a preferably circulating conveyor element for transporting the objects 12. The linear object conveyor can, for example, be a band, belt, chain, or plate conveyor. It is also possible for the linear object conveyor to be embodied as a long stator linear motor object conveyor or (magnetic) planar motor drive object conveyor which can move the objects 12 independently of one another by means of movement apparatuses (mover, shuttle).

The object conveyor 34 can support the objects 12 during transport, preferably on their base side and/or circumferential side. The object conveyor 34 can have object holders 36 (only schematically indicated in FIG. 2) for supporting the objects 12. The object holders 36 can preferably hold the objects 12 in base handling or neck handling.

It is possible that the object conveyor 34 has no separate object holders 36, and, for example, the objects 12 are simply supported on a, preferably circulating, conveying element (e.g., band, strap, belt, chains, or plates) of the object conveyor 34.

For example, the object holders 36 can each support an object 12. The object holders 36 can, for example, each have a container plate, a centering bell, a container clamp, and/or an inflation apparatus.

It is possible for the object conveyor 34 to be configured to rotate each of the transported objects 12 about its own vertical axis H. Preferably, the object holders 36 can be rotatable for rotating the objects 12 about their respective vertical axis H.

Optionally, the apparatus 28 can further have at least one detection device 38, 40.

The at least detection device 38 can be directed toward the object conveyor 34 or toward the objects 12 transported by the object conveyor 34.

For example, the detection device 38 can be arranged upstream of the laser-marking system 10 with respect to the transport direction T of the object conveyor 34 or can be integrated into the laser-marking system 10.

For example, the detection device 40 can be arranged downstream of the laser-marking system 10 with respect to the transport direction T of the object conveyor 34 or can be integrated into the laser-marking system 10.

The at least one detection device 38, 40 can, for example, have a camera apparatus, an LED detection apparatus, or a laser detection apparatus.

The detection device 38 can, for example, detect a curvature of a curved face of the object 12 to be laser-marked, e.g., in the form of a radius of curvature.

The detection device 40 can, for example, detect the laser mark on the curved face of the object 12. The captured laser mark can preferably be captured as an image file. The captured laser mark is preferably a vector graphic or a raster graphic.

The processing device 42 can, for example, be in communication with the control device 27 of the laser-marking system 10. The processing device 42 can send a two-dimensional representation for laser-marking to the control device 27 of the laser-marking system 10. The two-dimensional representation can preferably be received in the form of an image file. The two-dimensional representation can, for example, be a vector graphic or a raster graphic.

The processing device 42 can be configured to adjust the two-dimensional representation, as explained in more detail herein.

For example, the processing device 42 may be a PC or a server. Alternatively, the processing device 42 can be integrated with the control device 27.

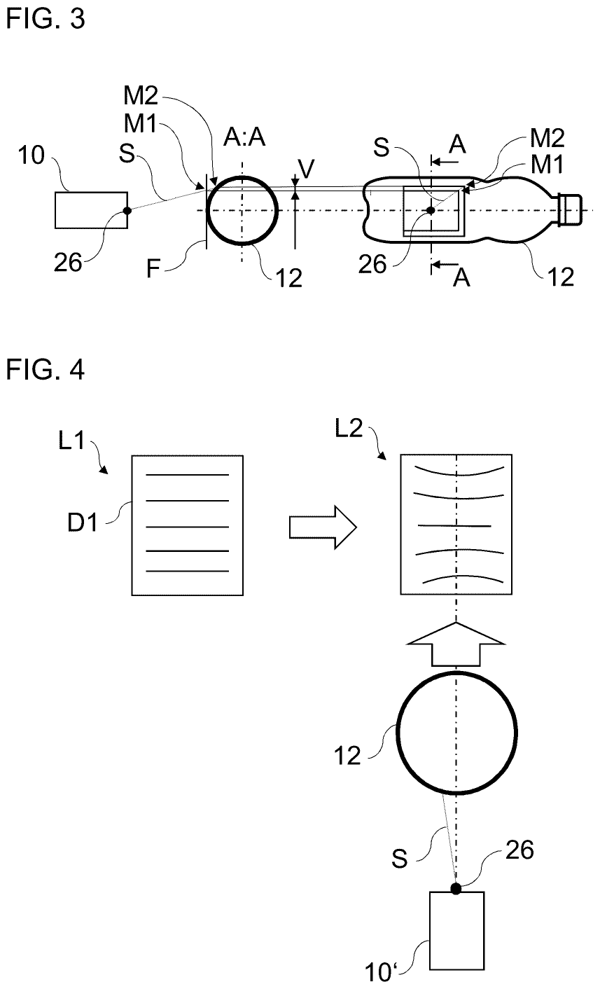

FIG. 3 shows that a laser beam S generated by the laser-marking system 10 impinges on a curved face of the object 12 to produce the laser mark. The focal plane F of the laser-marking system 10 can, for example, be substantially tangent to the curved face or be shifted slightly parallel thereto toward the center of the container. Preferably, the focal plane F can also represent a focus region (depth of focus). A theoretical focal plane and two parallel planes a few millimeters apart can form the focus region. The theoretical focal plane can then preferably not be tangential to the surface, but parallel thereto and slightly shifted toward the center of the container. This preferably increases the coverage of the focus region with the surface to be marked.

For example, in the edge region of the laser mark, a marking point M1 located in the focal plane F may deviate from an actual marking point M2 located on the curved face. The deviation is illustrated by way of example by the reference sign V. The deviation V can, for example, consist of an offset, a distortion, and/or a position error. The deviation V can be present not only in the conveying direction, but, alternatively or additionally, also in the direction of a container axis (x and y directions), depending upon the location of the point to be marked relative to the laser exit point.

FIG. 4 shows, purely schematically, that, due to the previously explained deviation V during laser-marking, an actual laser mark L2 may deviate from a desired laser mark L1. The desired laser mark L1 can be specified as a two-dimensional representation D1. The actual laser mark L2 may be distorted compared to the desired laser mark L1, in particular in edge regions of the actual laser mark L2.

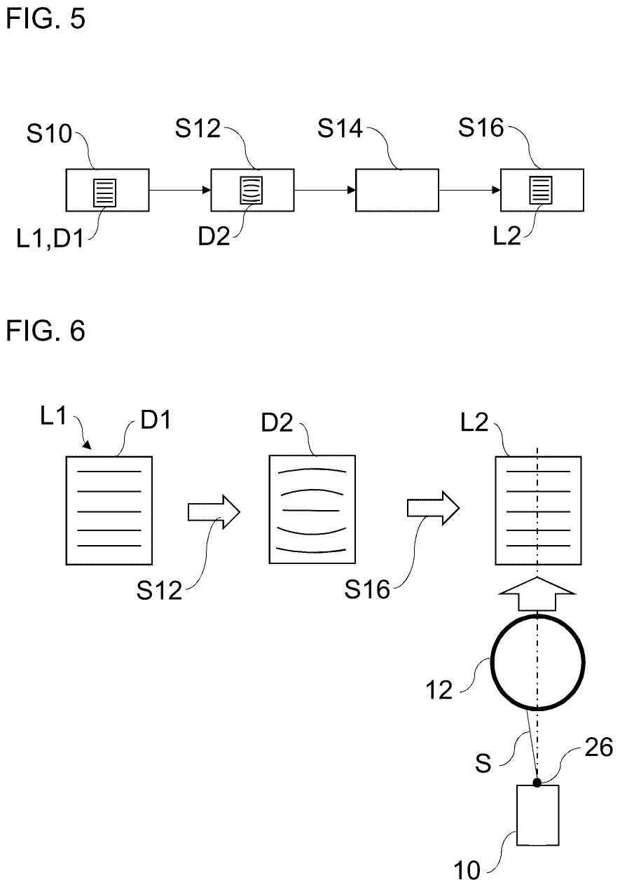

A special feature of the present disclosure is that this deviation between the desired laser mark L1 and the actual laser mark L2 can at least be reduced or even compensated for. This is explained below with reference in particular to FIGS. 5 and 6.

In a step S10, a two-dimensional representation D1 of a desired laser mark L1 is provided. Preferably, the two-dimensional representation is provided as an image file. Preferably, the two-dimensional representation can be a raster graphic or a vector graphic.

Preferably, the two-dimensional representation D1 can be provided on the processing device 42. For example, the two-dimensional representation D1 can be received by a communication interface and sent to the processing device 42. Alternatively, the two-dimensional representation D1 can be created, for example, on the processing device 42.

In a step S12, the provided two-dimensional representation D1 can be adjusted to an adjusted two-dimensional representation D2 depending upon a curvature of the object 12. Preferably, the two-dimensional representation D1 is adjusted as an image file (graphics file) to the two-dimensional representation D2.

Preferably, the provided two-dimensional representation D1 can be adjusted by means of the processing device 42 to the adjusted two-dimensional representation D2, preferably semi-automatically or fully automatically.

The curvature of the object 12 can be taken into account during adjustment, for example, in the form of a radius of curvature or a derived or related size of the object 12.

For example, the curvature can be detected by means of the detection device 38. Alternatively, the curvature can be specified, for example, by means of a user interface of the apparatus 28 or received by means of a communications interface of the apparatus 28.

The curvature can be individually detected, specified, or received for each object 12 or for each face of the object 12 to be laser-marked. Alternatively, the curvature can be detected, specified, or received once for a plurality of or all objects 12—for example, when commissioning the apparatus 28 or the laser-marking system 10

The curvature or the curved face preferably relates to a face segment of the lateral face of a circular cylinder.

Preferably, the adaptation comprises distorting the two-dimensional representation D1 to the two-dimensional representation D2. The two-dimensional representation D2 can therefore be a distortion of the two-dimensional representation D1. The distortion relative to the two-dimensional representation D1 can, for example, be more pronounced in edge regions of the two-dimensional representation D2 than in a central region of the two-dimensional representation D2.

Preferably, a distortion caused by the curvature of the curved face of the object 12 during laser-marking can be reduced or substantially compensated for by the distortion of the two-dimensional representation D1 relative to the two-dimensional representation D2. This preferably allows a distortion caused by the curvature of the curved face of the object 12 during laser-marking to be inverted. The distortion of the provided two-dimensional representation D1 can thus be opposite to a distortion caused by the curvature of the curved face of the object 12 during laser-marking.

In principle, the provided two-dimensional representation D1 can be adjusted taking into account determined geometric deviations between the curved face and the planar focal plane F. This can be done explicitly using given formulas, e.g., Euclidean geometry, etc. It is also possible for the adjustment of the two-dimensional representation D1 to be carried out by means of correction factors which are specified depending upon the curvature and are applied to the two-dimensional representation D1. Alternatively or additionally, the adjustment can be carried out taking into account laser beam angles at which a laser beam S emitted by the laser-marking system 10 strikes different points of the curved face.

In an optional step S14, the adjusted two-dimensional representation D2 can be transmitted to the control device 27 of the laser-marking system 10. Preferably, the adjusted two-dimensional representation D2 is transmitted as an image file to the control device 27 of the laser-marking system 10.

For example, the processing device 42 can send the adjusted two-dimensional representation D2 to the control device 27. The control device 27 can receive the transmitted, adjusted two-dimensional representation D2 from the processing device 42.

In a step S16, a laser mark L2 is laser-marked on the curved face of the object 12 by means of the laser-marking system 10 depending upon the adjusted two-dimensional representation D2. Preferably, the laser-marking of the laser mark L2 on the curved face is carried out in column-segment fashion (column-wise in adjacent segments).

Preferably, the laser-marking system 10 can be operated by the control device 27 during laser-marking, depending upon the adjusted two-dimensional representation D2.

For example, during laser-marking, the control device 27 can operate the marking head 16 depending upon the adjusted two-dimensional representation D2 to produce the laser mark L2.

For this purpose, the control device 27 can, for example, be configured to generate movement commands for the marking head 16 from the adjusted two-dimensional representation D2. The movement commands can preferably be drive signals for the drives 20, 24 of the mirrors 18, 22. The movement commands can be transmitted from the control device 27 to the marking head 16, preferably to the drives 20, 24 thereof. During laser-marking of the laser mark L2, the drives 20, 24 can be operated according to the transmitted movement commands.

It is possible, for example, for the control device 27 to further generate the movement commands depending upon a location-time component with respect to the (planned) laser beam S or the point of incidence thereof on the curved face of the object 12. This can preferably be done both in the height and width direction with respect to the focal plane F, because, for example, the laser beam S cannot perform laser-marking at all points at the same time, and the object 12 can move along the transport direction T during laser-marking.

Optionally, the laser mark L2 on the curved face can be detected after laser-marking by means of the detection device 40 or any other detection device (e.g., in a testing or quality assurance laboratory). Any deviation between the detected laser mark L2 and the desired laser mark L1 can be determined, for example, by means of the processing device 42.

Preferably, if a deviation is determined, the already adjusted two-dimensional representation D2 can be further adjusted, depending upon the determined deviation, in order to reduce or compensate for the deviation-for example, by means of the processing device 42.

Preferably, this further adjusted two-dimensional representation (e.g., vector graphic or raster graphic) can be transmitted to the laser-marking system 10. Preferably, the further adjusted two-dimensional representation is transmitted as an image file to the control device 27 of the laser-marking system 10.

For example, the processing device 42 can send the further adjusted two-dimensional representation to the control device 27. The control device 27 can receive the transmitted, further adjusted two-dimensional representation from the processing device 42.

Finally, a laser mark can be laser-marked on the curved face of at least one further object 12 by means of the laser-marking system 10 depending upon the further adjusted two-dimensional representation. This can be done, for example, analogously to the explanations for laser-marking the laser mark L2 depending upon the adjusted two-dimensional representation D2.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all the features of independent claim 1. All ranges specified herein are to be understood as disclosed in such a way that all values falling within the relevant range are individually disclosed, e.g., also as the relevant preferred, narrower outer limits of the relevant range.

### LIST OF REFERENCE SIGNS

10 laser-marking system
12 object
14 laser source
16 marking head
18 first mirror
20 first drive
22 second mirror
24 second drive
26 focusing optics
27 control device
28 apparatus for laser-marking
30 lens field
32 marking field
34 object conveyor
36 object holder
38 detection device
40 detection device
42 processing device
A:A section along line A-A in FIG. 3
D1 provided two-dimensional representation
D2 adjusted two-dimensional representation
F focal plane
H vertical axis
L1 desired laser mark
L2 actual laser mark
M1 theoretical marking point in the focal plane
M2 actual marking point
S laser beam
S10-S16 method steps
T transport direction
V deviation

What is claimed is:

1. A method for laser-marking objects with a curved face, wherein the method comprises:
providing a two-dimensional representation of a desired laser mark;
adjusting the provided two-dimensional representation depending upon a curvature of the curved face;
laser-marking a laser mark on the curved face of an object by means of a laser-marking system depending upon the adjusted two-dimensional representation.

2. The method according to claim 1, further comprising:
transmitting the adjusted two-dimensional representation to a control device of the laser-marking system,
wherein:
the laser-marking system or a marking head of the laser-marking system is operated by the control device during laser-marking, depending upon the transmitted, adjusted two-dimensional representation.

3. The method according to claim 1, wherein the laser-marking comprises:
generating movement commands for a marking head or drive signals for drives of mirrors of the marking head of the laser-marking system, depending upon the adjusted two-dimensional representation; and
transmitting the generated movement commands or the drive signals to the marking head.

4. The method according to claim 1, wherein at least one of the following conditions is met:
the two-dimensional representation is provided, adjusted, and/or transmitted as an image file; and
the two-dimensional representation is a raster graphic or a vector graphic.

5. The method according to claim 1, wherein:
the adjusting of the provided two-dimensional representation comprises distorting of the provided two-dimensional representation; or
the adjusting of the provided two-dimensional representation comprises distorting of the provided two-dimensional representation in edge regions of the provided two-dimensional representation; or
the adjusting of the provided two-dimensional representation comprises distorting of the provided two-dimensional representation in edge regions of the provided two-dimensional representation with increasing intensity of the distorting toward the edge regions.

6. The method according to claim 5, wherein the provided two-dimensional representation is distorted such that at least one of the following conditions is met:
a distortion caused by the curvature of the curved face during laser-marking is reduced or substantially compensated for;
a distortion caused by the curvature of the curved face during laser-marking is inverted; and
the distortion of the provided two-dimensional representation is opposite to a distortion caused by the curvature of the curved face during laser-marking.

7. The method according to claim 1, further comprising:
detecting the curvature by means of a detection device; or
specifying the curvature by means of a user interface; or
receiving the curvature by means of a communications interface.

8. The method according to claim 1, wherein:
the curved face is a face segment of a lateral face of a circular cylinder.

9. The method according to claim 1, wherein:
the adjusting of the provided two-dimensional representation is carried out by means of correction factors which are specified depending upon the curvature and are applied to the provided two-dimensional representation.

10. The method according to claim 1, wherein:
the adjusting is carried out taking into account laser beam angles at which a laser beam emitted by the laser-marking system strikes different points of the curved face.

11. The method according to claim 1, wherein:
the laser-marking system has planar field focusing optics; or
the laser-marking system has planar field focusing optics, having an F-theta lens, which define a planar focal plane.

12. The method according to claim 11, wherein:
the adjusting of the provided two-dimensional representation is carried out taking into account determined geometric deviations between the curved face and the planar focal plane.

13. The method according to claim 1, further comprising:
detecting the laser mark on the curved face by means of a detecting device; and
determining a deviation between the detected laser mark and the desired laser mark.

14. An apparatus for laser-marking objects having a curved face, wherein the apparatus has a laser-marking system and is configured to carry out a method according to claim 1.

15. The apparatus according to claim 14, wherein at least one of:
said objects are containers; and
the apparatus further has an object conveyor for conveying the objects along the laser-marking system.

16. The method of claim 1 wherein said objects are containers.

17. The method of claim 7, wherein at least one of:
the detection device is at least one of an optical, a camera-supported and a laser-supported detection device;
said step detecting the curvature by means of the detection device comprises detecting the curvature once for a plurality of objects;
said step of detecting the curvature by means of the detection device comprises detecting the curvature individually for each object;
said step specifying the curvature by means of the user interface comprises specifying the curvature once for a plurality of objects;
said step of specifying the curvature by means of the user interface comprises specifying the curvature individually for each object;
said step receiving the curvature by means of the communications interface comprises receiving the curvature once for a plurality of objects; and
said step of receiving the curvature by means of the communications interface comprises receiving the curvature individually for each object.

18. The method of claim 13 further comprising the steps of:
further adjusting the adjusted two-dimensional representation depending upon the determined deviation; and
laser-marking a laser mark on the curved face of at least one further object by means of the laser-marking system depending upon the further adjusted two-dimensional representation.

19. The method of claim 18 wherein said step of further adjusting the adjusted two-dimensional representation depending upon the determined deviation comprises reducing or compensating for the deviation.

20. The apparatus of claim 15 wherein at least one of:
said laser-marking objects comprise containers and wherein said object conveyor is a container conveyor; and
said conveying of the objects along the laser-marking system occurs during laser-marking by means of the laser-marking system.
